(19) United States
(12) Patent Application Publication
(10) Pub. No.: US 2019/0010913 A1
(43) Pub. Date: Jan. 10, 2019

(54) WATER WHEEL GENERATOR ASSEMBLY

(71) Applicant: HeliosAltas Corp., Rocklin, CA (US)

(72) Inventors: Phillip Chauvin, Lincoln, CA (US); Michael Thomas Carroll, Roseville, CA (US)

(21) Appl. No.: 16/127,910

(22) Filed: Sep. 11, 2018

Related U.S. Application Data
(63) Continuation-in-part of application No. 15/209,235, filed on Jul. 13, 2016.
(60) Provisional application No. 62/192,210, filed on Jul. 14, 2015.

(51) Int. Cl. F03B 13/10; F03B 7/00; H02K 7/18

(52) U.S. Cl. CPC F03B 13/10; H02K 7/1823; F03B 7/00

(57) ABSTRACT

A water wheel generator assembly that has a shell formed by a housing, which can be a pre-existing water wheel, and a pair of cover plates. The cover plates have weep holes and vents that maintain pressure, buoyancy, and balance, while improving efficiency and reducing wear on a generator. An internal ridge forces water out from a cavity of the shell. Shell bearings are inset in the cover plates that carry the weight of the shell, removing the weight on the generator. A hollow through shaft passes through the cover plates and allows the passage of cabling therethrough to permit stringing assemblies together. Within the shell, multiple generators can be strung together.

### CROSS REFERENCE TO RELATED APPLICATIONS

This application is a continuation-in-part of U.S. Ser. No. 15/209,235 filed Jul. 13, 2016, which claims the benefit of the priority of U.S. Provisional Application No. 62/192,210 filed Jul. 14, 2015, the contents of these applications are hereby incorporated by reference in their entirety.

### BACKGROUND OF THE INVENTION

This invention is directed towards a water wheel assembly. More specifically, and without limitation, this invention relates to a water wheel generator assembly.

The need for renewable energy or green energy is ever growing as climate change continues to impact the planet. According to the United States Geological Survey, as of 2014, hydroelectric energy constitutes the largest portion of the renewable energy consumed by the United States. Even so, the adoption of renewable energy only encompasses about 10% of the United States energy consumption. One of the biggest issues that hinders the adoptions of renewable energy is cost.

Advancements have occurred in the art. For instance, there are water wheel assemblies that integrate with the shell of the water wheel, (e.g., GB 2463113 (Price et al.)). These assemblies, however, suffer from a number of deficiencies.

To begin, these water wheel assemblies rely upon a single pair of bearings for the generator assembly to operate and also to carry the weight of the housing. This in turn causes greater wear on the generator assembly and reduces efficiency.

By positioning the generator assemblies at the exterior of the shell of the assembly the exposure to water is significant, which also increases wear. Although this arrangement allows for hookup of a single generator assembly at each end, it prevents multiple water wheel assemblies from being strung together. This limitation is made worse by the use of a solid through rod. Both of these deficiencies also prevent stringing generator assemblies together within the water wheel assembly.

Furthermore, assemblies of this nature are limited to a set size of generator assembly that must be compatible with the opening in the water wheel. This requires new, custom generator assemblies that cannot be swapped in and out easily, which also increases cost.

These assemblies also allow for water to pass through the opening so that water can assist in cooling the generator assembly. Although beneficial, this increases the wear on the generator assemblies. This configuration is also deficient in that insufficient amounts of water are passed through the openings in the generator assemblies to prevent imbalance, buoyancy issues, and excess pressure that can damage the generator assemblies. Further, only using water to cool the generator assembly is inadequate to maximize efficiency of the generator assembly and reduce associated wear.

Alternatively, some generator assemblies use completely sealed shells. High barometric pressure during operation causes damages to these configurations, which ultimately leads to leaks.

Moreover, presently many unpowered water wheels exist that use the power of flowing water to complete various tasks. The process to convert these water wheels to produce electricity is expensive, complex, and time consuming.

Thus it is a primary objective of this invention to provide a water wheel generator assembly that improves upon the art.

Another objective of this invention is to provide a water wheel generator assembly that reduces wear on a generator assembly and increases generator assembly efficiency.

Yet another objective of this invention is to provide a water wheel generator assembly that provides for stringing together generator assemblies and water wheel generator assemblies.

Another objective of this invention is to provide a water wheel generator assembly that is capable of being easily fitted to an unpowered water wheel to produce electricity.

Yet another objective of this invention is to provide a water wheel generator assembly that can be universally mounted.

Another objective of this invention is to provide a water wheel generator that is cost effective.

These and other objectives, features, and advantages of the invention will become apparent from the specification and claims.

### SUMMARY OF THE INVENTION

In general, the present invention relates to a water wheel generator assembly. The water wheel generator assembly includes a shell formed by a housing and a pair of cover plates, which forms a cavity. The housing in some embodiments is a pre-existing water wheel. A through shaft is received through the pair of cover plates and is used to anchor the water wheel generator assembly. The through shaft is hollow in some arrangements and configured to allow cables and other wiring to pass through such that multiple water wheel generator assemblies can be connected to one another.

The cover plates have a plurality of weep holes that align with an internal ridge inside the housing. The weep holes allow water to be pushed out of the shell while also preventing or limiting the entry of water into the cavity. The internal ridge is configured to force additional water out of the shell due to the angle of the internal ridge and the force present during operation of the water wheel generator assembly. Multiple weep holes are needed to ensure sufficient removal of water, which in turn provides a consistent pressure within the housing thereby preventing damage.

The cover plates also have a plurality of vents that allow for heat from the generator to escape from the cavity. The use of a breathable material facilitates this process while preventing or limiting the entry of water. The vents also provide buoyancy and balance.

Positioned within an opening of the cover plates are shell bearings that bear the weight of the shell. This reduces the wear on the generator and allows for multiple generators to be positioned within the shell—not just at the outside ends of the housing.

### BRIEF DESCRIPTION OF THE DRAWINGS

FIG. 1 is a perspective view of a water wheel generator assembly;

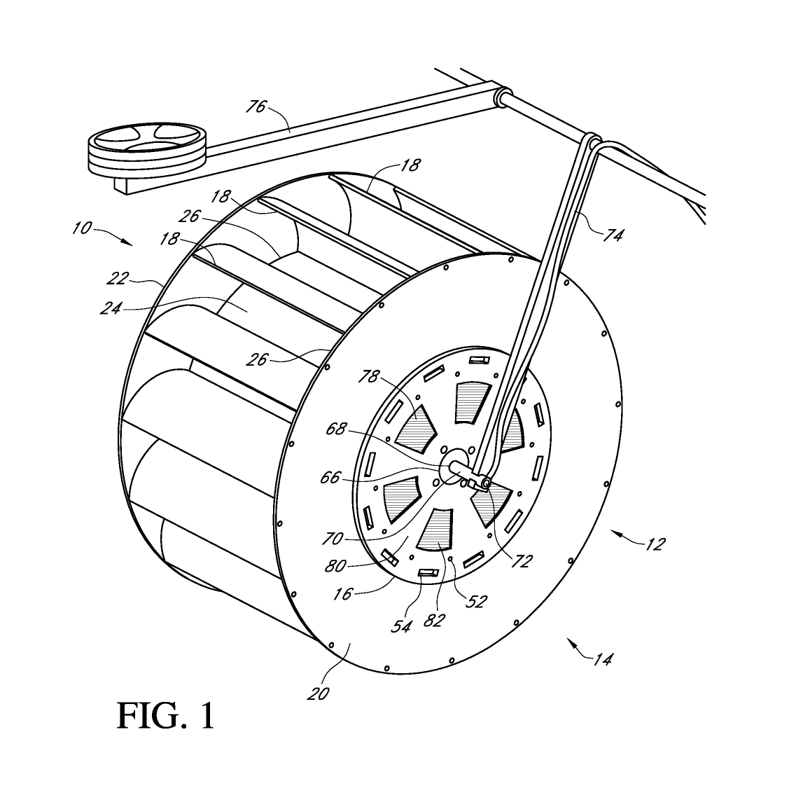

FIG. 2 is a side view of a water wheel generator assembly;

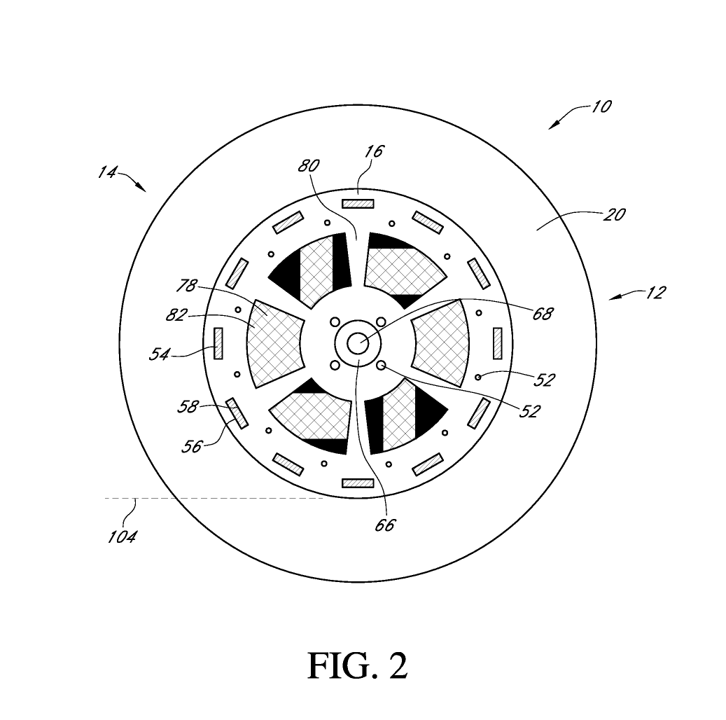

FIG. 3 is a side view of a cover plate of a water wheel generator assembly;

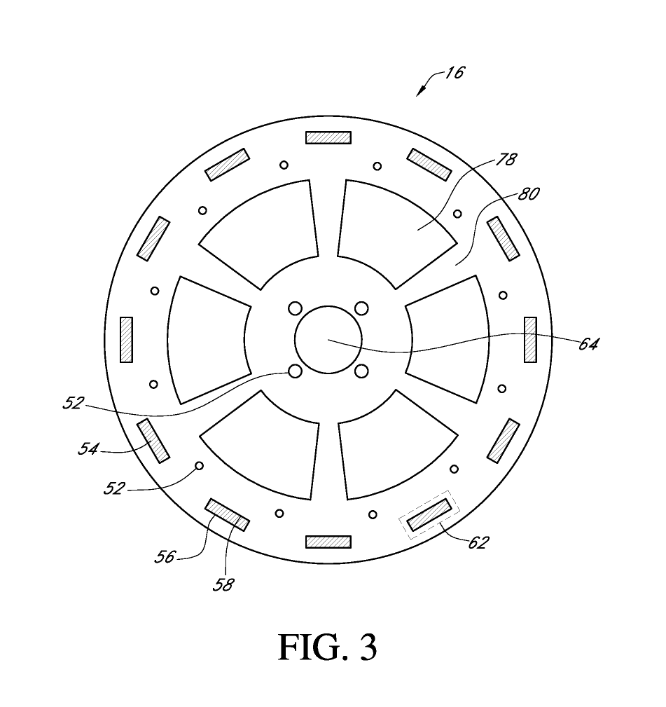

FIG. 4 is a front-cross section view of a water wheel generator assembly;

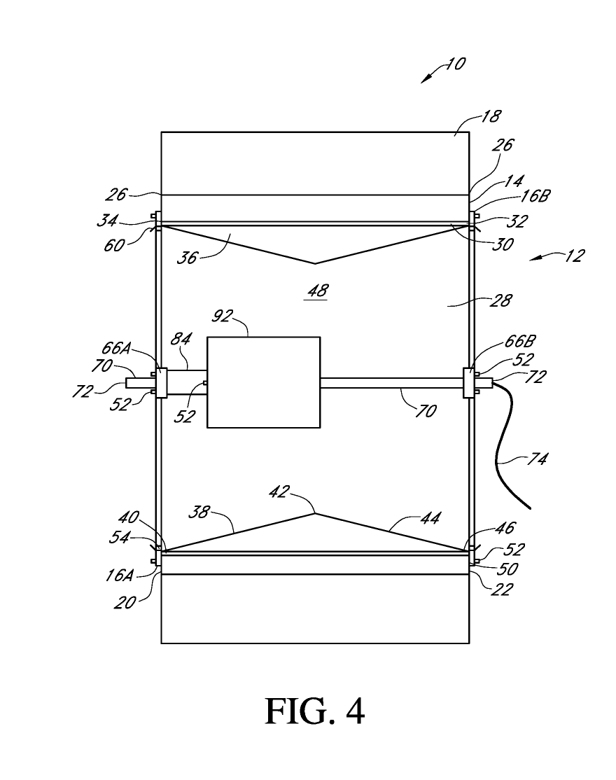

FIG. 5 is a front-cross section view of a water wheel generator assembly;

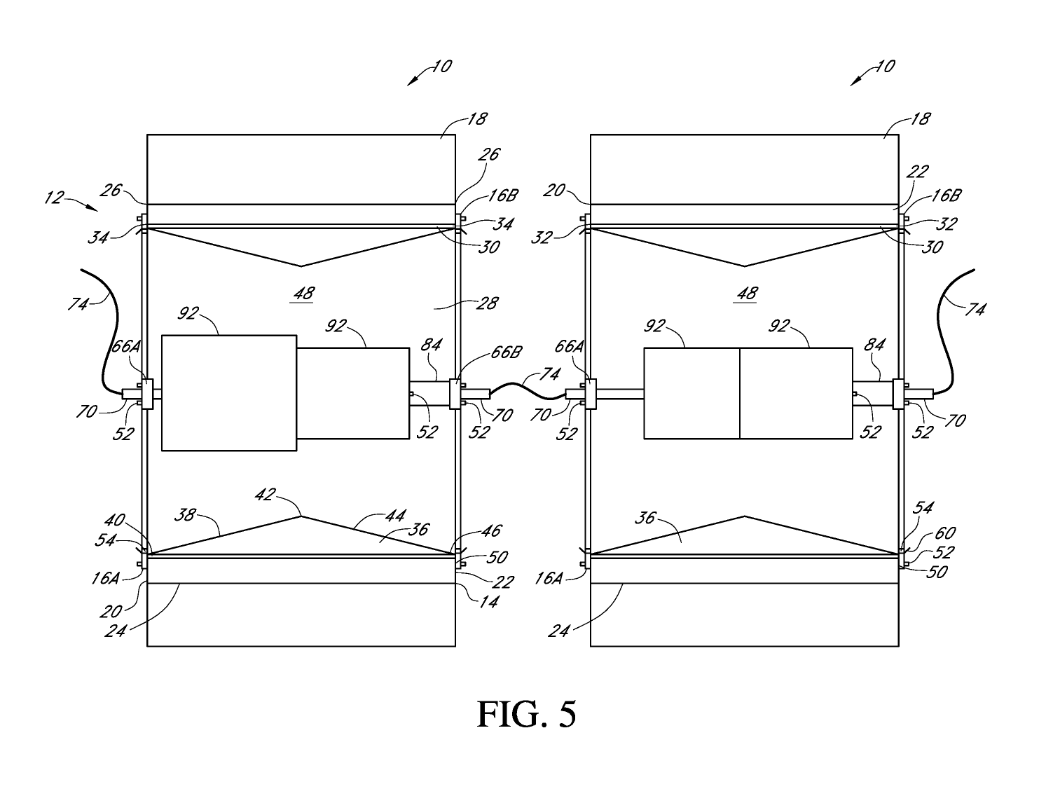

FIG. 6 is a front-cross section view of a water wheel generator assembly; and

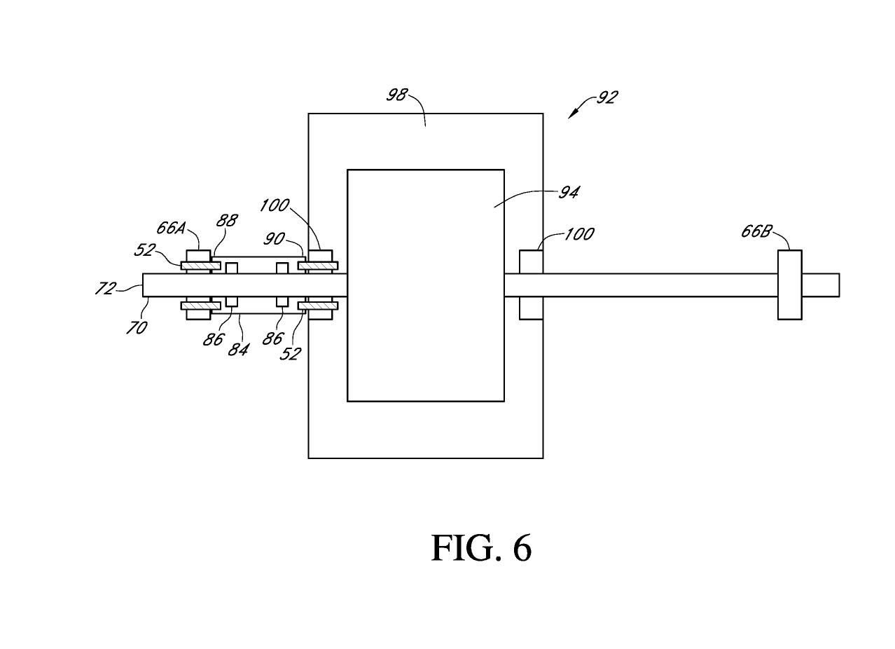

FIG. 7 is a cross section view of a generator.

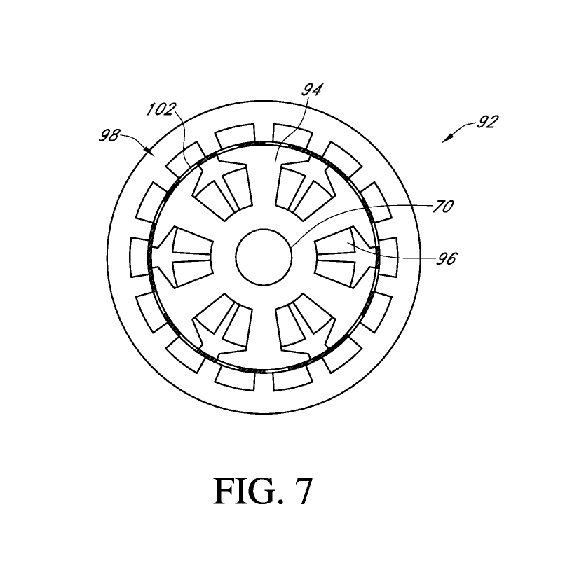

### DETAILED DESCRIPTION

With reference to the Figures a water wheel generator assembly 10 is shown having a shell 12 having a housing 14, a pair of cover plates 16, and a plurality of blades 18 extending radially outward from the housing 14.

The housing has a first sidewall 20 and a second opposing sidewall 22, both of which are circular in some arrangements. Positioned between the first sidewall 20 and the second sidewall 22 is an exterior continuous end wall 24 that forms a cylinder. The first sidewall 20 and second sidewall 22 are connected to opposing ends 26 of the exterior continuous end wall 24.

The plurality of blades 18 extend radially outward from the exterior continuous end wall 24 and between the first sidewall 20 and the second sidewall 22. As seen in the exemplary embodiment, the plurality of blades 18 extend between a portion 26 of the first sidewall 20 and the second sidewall 22 that extends outwardly past the exterior continuous end wall 24 due to having a diameter that is larger than a diameter of the exterior continuous end wall 24. This provides rigidity to the first sidewall 20, the second sidewall 22, and the plurality of blades 18.

Alternatively, the first sidewall 20 and the second sidewall 22 have a substantially similar diameter as a diameter of the exterior continuous end wall 24. In this alternative arrangement, the plurality of blades 18 extend between the opposing ends 26 and radially outward past the exterior continuous end wall 24.

The first sidewall 20 and the second sidewall 22 have an opening 28 that extends through the housing 14. An interior continuous end wall 30 has opposing ends 32 that extend between the first sidewall 20 and the second sidewall 22, such that the interior continuous end wall 30 aligns with opposing edges 34 of the opening 28.

An internal ridge 36 extends inwardly from the opposing ends 32 of the interior continuous end wall 32. As seen in the exemplary embodiment, the internal ridge 36 has a first portion 38 that extends from a first end 40 to a peak 42 and a second portion 44 that extends from a second end 46 to the peak 42. In this arrangement, the internal ridge 36 has a triangular profile that extends around the internal circumference of the interior continuous end wall 30. The first end 40 and the second end 46 align with the opposing edges 34 of the opening 28.

Alternatively, the housing 14 is an existing water wheel having substantially the same configuration as that disclosed thus far and that is modified as disclosed further herein.

A first cover plate 16A of the pair of cover plates 16 connects to the first sidewall 20 and a second cover plate 16B connects to the first sidewall 22 thereby forming a cavity 48 between the pair of cover plates 16 and the interior continuous end wall 30. In this configuration, the cavity 48 is virtually enclosed on all sides except as detailed further herein.

As seen in the exemplary embodiment, the pair of cover plates 16 have a diameter that is greater than the diameter of the opening 28 of the housing 14 such that an overlapping portion 50 of the pair of cover plates 16 overlaps with the first sidewall 20 and the second sidewall 22, respectively. A plurality of connectors 52 connect the overlapping portion 50 to the first sidewall 20 and the second sidewall 22.

Between each set of the plurality of connectors 52 is at least one weep hole 54 in a radial fashion. In this arrangement, a weep hole 54 is positioned on either side of each connector 52. In the exemplary embodiment, the weep holes 54 have a slotted or rectangular shape, though any suitable shape is contemplated, with an exterior end 56 that is aligned with the position of the first end 40 or the second end 46 of the internal ridge 36. An internal end 58 of each weep hole 54 is positioned further inward with respect to the exterior end 56. In this arrangement, each weep hole 54 provides passage for water passing through the cavity 48 of the housing 14 that aligns with interior continuous end wall 30 and extends inwards. The configuration of the internal ridge 36 increases the amount of water forced out of the cavity 48 due to the angle of the internal ridge 36 and motion during operation. Further, the presence of multiple weep holes 54 is needed to sufficiently remove water during operation while also limiting the amount of pressure built up within the shell 12.

In some embodiments, one or more of the weep holes 54 have a lip 60 that extends outwardly away from the housing 14. The lip 60 prevents or limits water from entering the housing during operation. Alternatively, check valves 62 are positioned between the pair of cover plates 16 and the cavity 48 to further limit or prevent the entry of water into the shell 12.

The pair of cover plates 16 each have an opening 64 that are in alignment with each other when connected to the housing 14. A pair of shell bearings 66 are positioned within or inset in the opening 64 of the cover plates 16 such that a first shell bearing 66A is positioned within the first cover plate 16A and a second shell bearing 66B is positioned within the second cover plate 16B, respectively. The shell bearings 66 are configured to bear the weight of the shell 12 during operation.

The shell bearings 66 have an opening 68 that receives a through shaft 70 that extends through the shell bearing 66 in the first cover plate 16A, the cavity 48 of the housing 14, and the second cover plate 16B. In some embodiments of the present invention, the through shaft 70 is hollow and has opposing open ends 72 that permit the passage of materials, such as cabling 74. The through shaft 70 is mounted to an anchoring point, such as a pendulum 76 in some embodiments thereby allowing for efficient interaction with a waterway.

Positioned between the opening 64 in each of the pair of cover plates 16 are a plurality of vents 78, that extend radially outward from the opening 64 such that the plurality of vents 78 increase in size away from the opening 64. Between each of the plurality of vents 78 is a spoke 80. In other arrangements, a single vent 78 extends around the opening 64 in an O-shape. The plurality of vents 78 have a breathable material or reinforced breathable material 82, such as a screen or the like. The plurality of vents 78 are configured to release heat from the water wheel generator assembly 10 thereby increasing efficiency while maintaining buoyancy and balance.

A drive shaft 84 is positioned on and rotatably mounted to the through shaft 70. One or more drive shaft bearings 86 are positioned within the drive shaft 84 and facilitate rotation about the through shaft 70. A first end 88 of the drive shaft 84 is connected to the shell bearings 66 by connectors 52 and a second end 90 of the drive shaft 84 is connected to a generator 92 that is positioned within the shell 12.

The generator 92 in one embodiment has a stator 94 that is configured to statically mount to the through shaft 70. The stator 94 has a plurality of stator coils 96. An outer rotor 98 that has a pair of rotor bearings 100 is positioned around and rotatably mounted to the stator 94. One or more magnets 102 of the outer rotor 98 interact with the stator coils 96 during rotation. The generator 92 can be a rotary flux or axial flux generator 92 as well.

As shown in the exemplary embodiment, the second end 90 of the drive shaft 84 is connected to one of the rotor bearings 94. The drive shaft 84 is configured to universally connect to various generators 92 known in the art, which in turn makes replacement easy and low cost.

The shell bearings 62 permit multiple generators 92 to be connected in series within the shell 12. For instance, additional generators 92 can be strung together in series by connecting the rotor bearing 94 of one generator 92 to the rotor bearing 94 of another generator 92. Alternatively, another drive shaft 84 can be connected between adjacent generators 92. In this way, the number of generators 92 operating in a single water wheel generator assembly 10 is not limited to one generator 92 or two generators 92 connected at opposing ends 30 of the opening 28 of the housing 14. Rather, three or more generators 92 working in series is possible. Each generator 92 of the present invention is protected from excess wear as well due to positioning within the shell 12.

Additionally, the ability to position generators 92 within the shell 12 permits the use of generators 92 of different sizes and capacities. The drive shaft 84 of the present invention is configured to universally connect to generators 92 of different sizes and capacities, thereby making the present invention adaptable to a variety of budgets and conditions present in an environment.

In some configurations, multiple water wheel generator assemblies 10 are connected to each other or strung together. This is possible by passing the necessary cabling through the through shaft 66 of each water wheel generator assembly. This in turn simplifies installs while increasing power production.

To further increase the efficiency, the water wheel generator assembly 10 is positioned so that the lowest point of cover plates 16 is above the highest point of a water level 104. In this arrangement, water is further prevented or limited from entering the weep holes 54.

During operation, one or more generators 92 are mounted to the through shaft 70 and connected to the drive shaft 84. The first cover plate 16A is connected to the housing 14 and the drive shaft 84. The second cover plate 16B is then connected to the housing 14, thereby forming the shell 12 around the generator 92.

The shell 12 is then placed in water flow with the through shaft 70 anchored. As water passes and contacts the plurality of blades 18, the shell 12 rotates with centrifugal force. The size and position of the weep holes 54 prevents or limits entry of water from entering the cavity 48 of the shell 12, as does the breathable material 82 of the plurality of vents 78.

Any water that is present is forced out of weep holes 54 by the internal ridge 36 that directs water directly out of the aligned weep holes 54, thereby reducing contact between the generator 92 and water and maintains a consistent pressure inside the shell 12. The plurality of vents 78 increase the efficiency of the generator 92 by releasing heat from the shell 12 and increasing buoyancy and balance. In this way, the weep holes 54 and plurality of vents 78 protect the generator 92 from unnecessary wear.

In the event that any repairs, replacements, or modifications are needed, one of the cover plates 16 is removed providing easy access to the generator 92 or simplistic addition or removal of generators 92.

In some operations, the housing 14 is an existing water wheel, which is easily converted into the water wheel generator assembly 10 in a similar manner as detailed herein.

Therefore, a water wheel generator assembly 10 has been provided that reduces wear on a generator assembly and increases generator assembly efficiency, provides for stringing together generator assemblies and water wheel generator assemblies, that is capable of being easily fitted to an unpowered water wheel to produce electricity, that can be universally mounted, that is cost effective, and improves upon the art.

From the above discussion and accompanying figures and claims it will be appreciated that the water wheel generator assembly 10 offers many advantages over the prior art. It will be appreciated further by those skilled in the art that various other modifications could be made to the device without parting from the spirit and scope of this invention. All such modifications and changes fall within the scope of the claims and are intended to be covered thereby. It should be understood that the examples and embodiments described herein are for illustrative purposes only and that various modifications or changes in the light thereof will be suggested to persons skilled in the art and are to be included in the spirit and purview of this application.

What is claimed is:

1. A water wheel generator assembly comprising:
a first cover plate and a second cover plate connected to a housing that form a shell having a cavity;
a first shell bearing positioned in an opening in the first cover plate and a second shell bearing positioned in an opening in the second cover plate;
a through shaft received through the first shell bearing and a second shell bearing;
a generator mounted to the through shaft within the cavity; and
a drive shaft connected to the first shell bearing and the generator.

2. The water wheel assembly of claim 1 wherein the through shaft is hollow and configured to receive wiring to connect multiple water wheel assemblies together.

3. The water wheel assembly of claim 1 further comprising the housing having an interior continuous side wall and an internal ridge that extends inwardly from opposing ends of the interior continuous end wall.

4. The water wheel assembly of claim 3 further comprising the internal ridge having a first portion that extends from a first end to a peak and a second portion that extends from a second end to the peak.

5. The water wheel assembly of claim 4 wherein the internal ridge has a triangular profile.

6. The water wheel generator assembly of claim 4 wherein the internal ridge extends around the internal circumference of the interior continuous end wall.

7. The water wheel generator assembly of claim 4 wherein the first end and the second end align with a plurality of weep holes in the first cover plate and the second cover plate.

8. A water wheel generator assembly comprising:
a shell having a cavity;
a hollow through shaft received through the shell;
a generator mounted to the through shaft within the cavity; and
a drive shaft connected to the first shell bearing and the generator.

9. A water wheel generator assembly comprising:
a shell having a cavity;
the shell having an interior continuous side wall and an internal ridge that extends inwardly from opposing ends of the interior continuous end wall;
a through shaft received through the shell; and
a generator mounted to the through shaft.

10. The water wheel generator assembly of claim 10 wherein the internal ridge has a triangular profile.

11. The water wheel generator assembly of claim 10 wherein the internal ridge extends around the internal circumference of the interior continuous end wall.

12. The water wheel generator assembly of claim 10 further comprising the internal ridge having a first portion that extends from a first end to a peak and a second portion that extends from a second end to the peak.

13. The water wheel generator assembly of claim 13 wherein the first end and the second end align with a plurality of weep holes in the shell.
